(19) United States
(12) Patent Application Publication
(10) Pub. No.: US 2011/0127996 A1
(43) Pub. Date: Jun. 2, 2011

(54) APPARATUS AND METHOD FOR DETERMINING THE ROLL ANGLE OF A DEVICE WITH A HOUSING

(75) Inventors: Volkmar Schultze, Rutha (DE); Wilfried Andrä, Jena (DE); Katja Peiselt, Jena (DE)

(73) Assignee: RAYONEX Schwingungstechnik GmbH, Lennestadt (DE)

(21) Appl. No.: 12/304,639

(22) PCT Filed: Jun. 13, 2007
(86) PCT No.: PCT/EP2007/005210

§ 371 Date: Mar. 31, 2009

(30) Foreign Application Priority Data
Jun. 14, 2006 (DE) 10 2006 027 979.4
Nov. 9, 2006 (DE) 10 2006 052 825.5

(51) Int. Cl. G01B 7/30

(52) U.S. Cl. 324/207.25

(57) ABSTRACT

The invention relates to an apparatus for determining the roll angle of a device having a housing, wherein a coil, which is arranged on or in the housing so as to be rigid in relation to the housing of the device, and an actuation electronic system, which generates voltage profiles that are limited chronologically by means of the coil, are provided.

The invention relates to an apparatus and a method for determining the roll angle of a device with a housing. Such apparatuses and methods are employed in particular in medical technology.

DE 102 25 518 A1 and DE 10 2004 058 272 A1 describe apparatuses which are used to determine the location of a transmit head. In these apparatuses, a rotating magnetic field is measured with a remotely located three-axes magnetic field sensor. The origin of the rotating magnetic field and therefore of the transmit head can be determined with this approach. When the magnetic field rotates about an axis which has at least one component in a preferred direction of the transmit head (preferable along the longitudinal axis of the transmit head), this preferred direction can be determined in addition to the location by using this system incorporating the rotating magnetic field and the three-axes sensor. For example, the advance direction of a medical device can then be determined, if the transmit head is part of the medical device. As disclosed in DE 102 25 518 A1 and DE 10 2004 058 272 A1, the rotating magnetic field is produced by a permanent magnet which rotates about its axis. It is also disclosed that an electromagnet can be used instead.

In addition to the location of the transmit head and the orientation of one of its preferred directions, information about its angular position is of interest. Angular position is hereby understood as the orientation of the housing in relation to a rotation about a rotation axis. For example, it may be of interest to determine the rotation position of a reference point about the longitudinal axis of the device, i.e., to determine if the device is relative to the rotation axis in, for example, an initial position or in an “overhead” position. In drilling installations, this angular position is frequently referred to as “roll angle”. The term “roll angle” is here used as an alternative term for the aforedescribed rotation position.

The method disclosed in DE 102 25 518 A1 does not permit the determination of the roll angle. The apparatus disclosed in DE 10 2004 058 272 A1 employs a second magnet in addition to the first magnet which rotates inside the transmit head. The first magnet rotates about a rotation axis that corresponds to the advance direction of the device. However, this apparatus has two significant disadvantages. On one hand, the signals can only be evaluated when the magnet rotates, because the signal would otherwise disappear in the constant ambient field. Because the roll angle must often already be determined when the device is at rest, this approach has significant disadvantages. In addition, the ambiguity of the roll angle cannot be eliminated, meaning that the result is the same if the roll angles are 180° apart.

Accordingly, it is an object of the invention to propose an apparatus and a method for determining the roll angle of the device with the housing, wherein the roll angle can be reliably determined also when the housing is at rest.

The object is attained by the subject matter recited in the independent claims. Advantageous embodiments are recited in the dependent claims.

The invention is based on the concept to provide a coil which is arranged on or in the housing and has fixed relationship relative to the housing, wherein a time-limited voltage profile is generated with control electronics. The control electronics generates with the coil in particular an AC voltage, wherein the shape of the voltage can be changed. For example, the control electronics together with the coil can produce a pulse-shaped voltage profile, for example, if the control electronics terminates the signal after the first half-wave. Alternatively, the control electronics can generate with the coil, for example, a damped oscillation, which preferably decays after a short time. In addition to these exemplary possible embodiments, other time-limited voltage profiles may also be generated with the coil.

The time-limited voltage profile impresses a characteristic feature on the magnetic field surrounding the device which permits a conclusion about the roll angle of the device from a measurement and analysis of the temporal change of the magnetic field.

In a preferred embodiment, the coil axis is oriented perpendicular to the rotation axis of the device, if the device is, for example, translated in the direction of the longitudinal axis, while rotating about its longitudinal axis. Likewise, the coil may also be inclined with respect to the rotation axis. The roll angle can then be determined from the component of the magnetic field produced by the coil and oriented perpendicular to the advance direction.

In a preferred embodiment of the invention, the apparatus of the invention includes a magnetic field sensor, preferably a three-axes magnetic field sensor, and an evaluation unit. The magnetic field sensor is preferably stationarily arranged in relation to the device, which moves rotationally and optionally translationally relative to the magnetic field sensor.

In a preferred embodiment, the control electronics generates with the coil a pulse-shaped voltage profile. This pulse-shaped voltage profile may be, for example, the first half-wave of an AC voltage. The control electronics can also apply a pulse-shaped signal in other ways.

In an alternative, likewise preferred embodiment, the control electronics produces with the coil a voltage profile resembling a damped oscillation that decays after a time t.

In a preferred embodiment, the control electronics is configured to repeat the voltage profile with a repeat frequency f. Advantageously, the magnetic field for determining the roll angle of the device can be better evaluated if it is known that the voltage profile is produced with a fixed repeat frequency.

In a preferred embodiment, the control electronics is configured so that the amplitude and the length of the pulse and/or the type of damping or the decay time t as well as the repeat frequency f are adjustable.

In a preferred embodiment, the coil has a positive terminal and a negative terminal. The control electronics generates a current flow always in the same direction from one of the terminals to the other terminal. A magnetic field is then generated by the coil whose direction is defined by the polarity of the electric current flowing through the transmit coil. The hereby produced magnetic field has then always the same polarity. The necessary additional information about the orientation of the magnetic field is thereby generated without requiring external intervention; this information is not accessible for a permanent magnet or a coil arrangement operated with AC current. The unchanging polarity then enables determination of the roll angle without having identical information when two roll angles are different by 180°.

In a preferred embodiment, the apparatus includes a second a dipole arranged in the housing, which can be driven about a rotation axis with a relative speed OMEGA relative to the housing. In a preferred embodiment, the relative speed OMEGA is adjustable. For example, with the approach disclosed in DE 10 2004 058 272 A1, both the location of the device relative to the magnetic field sensor and also a corresponding preferred direction of the device, for example a longitudinal axis of the device or an advance direction of the device, can be determined based on the second, freely rotating dipole. The device of the invention can then be used to determine, in addition to the roll angle, also the position and the preferred direction or advance direction of the device.

The second dipole may preferably be implemented as a permanent magnet which rotates in the housing of the device. Alternatively, an electromagnet can be employed instead of the permanent magnet.

In a preferred embodiment, the rotation axis of the second dipole is oriented perpendicular to the coil axis of the coil which is fixedly arranged on or in the housing and which is used to produce with the control electronics the time-limited voltage profile.

In a preferred embodiment, the apparatus includes a receiver which is disposed external to the device and measures outside the device three time-dependent, mutually perpendicular magnetic field components of the magnetic field. Advantageously, the evaluation algorithms for determining the roll angle and, if desired, the determination of the location of the device (position) and its preferred direction are constructed from measurement values representing three mutually perpendicular magnetic field components of the magnetic field outside the device. The magnetic field sensor (receiver) may also be configured differently, even if this would increase the complexity of the evaluation algorithms.

The apparatus of the invention is preferably employed for determining the roll angle of the drill head of a drilling device, wherein the drill head includes a housing. In particular, the drill head is a drill head of a controllable drilling assembly, preferably a horizontal drilling assembly. The device can also be a soil displacement hammer, a part of an impact drilling device, a part of a burst and/or expansion device, or a rod assembly or a length of a rod assembly. The aforementioned devices involve especially preferred devices for trenchless drilling or trenchless pipe installation.

The apparatus of the invention is also used for determining the roll angle of a device for obtaining endoscopic images for diagnostic purposes, obtaining electrical or electrophysiological data, examining blood vessels and treatment of vessel constrictions, performing and/or monitoring surgical procedures on the brain, heart or the intestinal tract, implantation of organ and tissue transplants, joint prostheses, electromagnetic sensors and pulse transmitters, heart pacemakers, vessel transplants and catheters, removal and destruction of gallstones or kidney stones, inflamed tissue, tumor tissue, bone and joint material, targeted release of therapeutic substances on diseased tissue or tumor tissue, or irradiation of tumor tissue.

The apparatus is also preferably used for localizing, determining the axis directions or the roll angle about a certain axis and/or for controlling a medical, micro-surgical or endoscopic device.

According to the method of the invention, for determining the roll angle of a device with a housing, a control electronics with a coil produces a time-limited voltage profile, wherein the coil is fixedly disposed relative to the housing on or in the housing. The magnetic field is then measured outside the housing with a receiver, and the roll angle is determined from the temporal change of the measurement results.

In a preferred embodiment of the method, the orientation of the coil normal is determined with the method disclosed in DE 102 25 518 A1 and DE 10 2004 058 272 A1. Because the orientation can be related to the rotation axis of the drill head, for example the longitudinal axis, the roll angle can be determined from the fixed position of the coil in the housing. The rotation axis of the drill head can then be determined solely with the coil of the invention by determining several coil normals while the drill head is rotating. The direction of the rotation axis (advance direction) of the drill head is then the normal on the plane or the axis of the cone defined by the coil normal. Advantageously, the determination of the coil normal according to the invention can also be combined with the simultaneous use of the rotating second dipole described in DE 102 25 518 A1 and DE 10 2004 058 272 A1. The advance axis can then be readily obtained by measuring the magnetic field of the rotating magnet, and the roll angle can also be readily obtained by measuring the orientation of the magnetic field of the coil. The same receiver can be used for both measurements.

The magnetic field produced by the coil is independent of the rotation of the drill head, so that the measurement can be performed without problems even at rest. On the other hand, the roll angle can also be determined while the drill head is rotating. With a fixed repeat frequency of the coil, the signal for determining the roll angle can be easily identified from background interference signals and a DC field by using frequency filters.

The invention will now be described with reference to the drawings which illustrate certain exemplary embodiments.

FIG. 1 shows a first embodiment of control electronics for the apparatus of the invention,

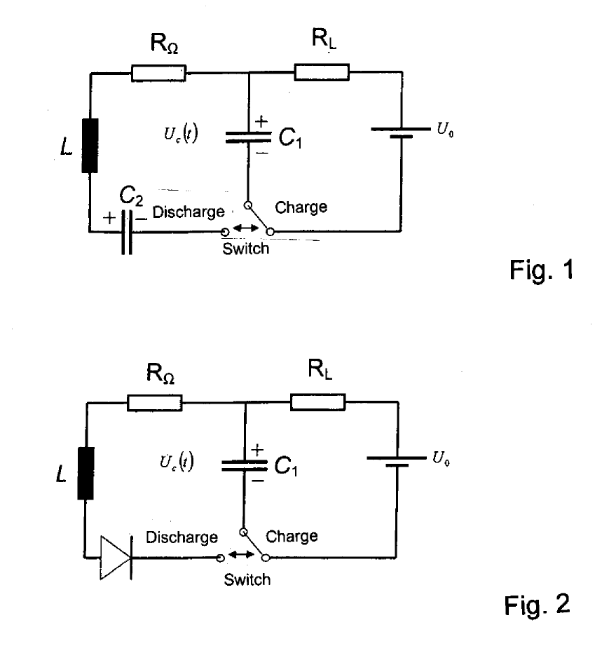

FIG. 2 shows a second embodiment of control electronics for the apparatus of the invention,

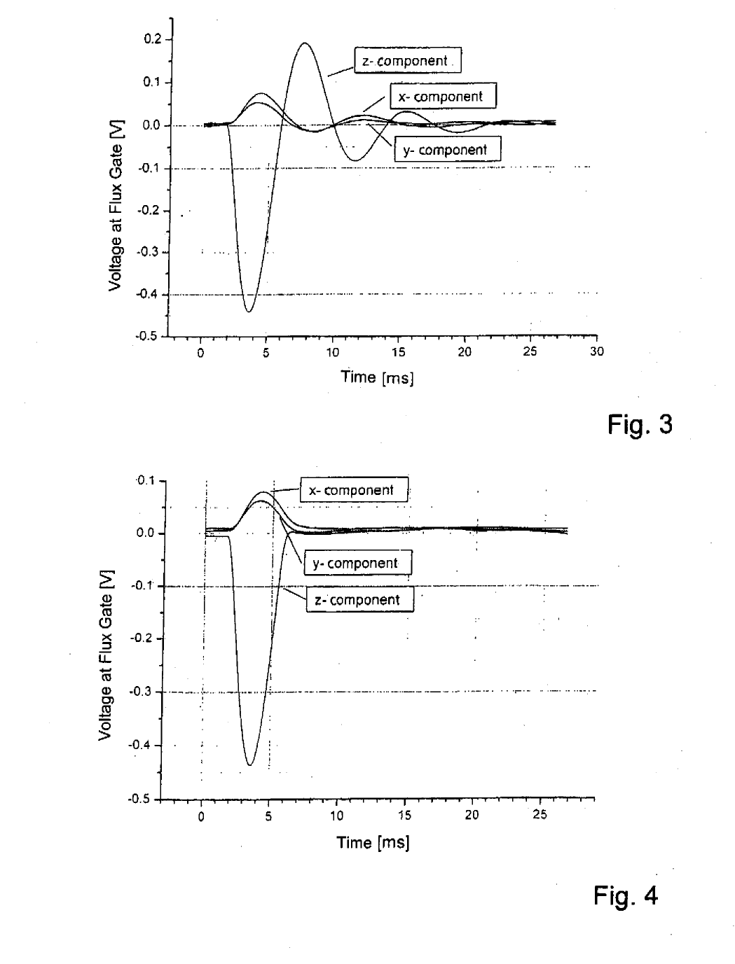

FIG. 3 shows the measurement result from a magnetic field sensor with three orthogonal measurement directions after measuring a time-limited voltage profile of the type generated with the control electronics of FIG. 1 and a coil, and

FIG. 4 shows the measurement results of a magnetic field sensor with three orthogonal measurement directions after measuring a time-limited voltage profile of the type generated with the control electronics of FIG. 2 and a coil.

The control circuit depicted in FIG. 1 produces a damped oscillation, whereas the control circuit depicted in FIG. 2 terminates the oscillation after the first half-wave, i.e., produces a pulse. That damped oscillation or the pulse are generated with a suitable repeat frequency, for example 1 Hz.

Preferably, the current through the transmit coil is supplied by a charge storage device (e.g., battery or capacitor) which can be repeatedly charged in the drill head. When a predetermined threshold voltage is reached, a switch is closed which allows the charge (for example, as a current pulse) to flow through the transmit coil. Charging can preferably be performed through rotation of a permanent magnet (e.g., driven by the drill flush typically employed in impact drilling systems) in an induction coil, which then produces an AC voltage that is subsequently rectified and charges the charge storage device. In a preferred embodiment, the transmit coil is also the induction coil. In another preferred embodiment, the charge storage device is charged by an external battery or by a battery located in the drill head. Preferably, this battery can also be used for driving the rotating permanent magnet that is also located in the drill head.

In one particular embodiment, the rotating permanent magnet is simultaneously used to determine the position and advance direction of the drill head, using the approach disclosed in DE 102 25 518 A1 and DE 10 2004 058 272 A1. The magnetic field of the coil is superimposed on the field of the rotating permanent magnet. Both can be separated and separately processed because of their different time dependence.

In a preferred embodiment, this transmit coil is integrated in the housing with an aforedescribed arrangement of a rotating second dipole for generating a permanent alternating magnetic field. The evaluation of this permanent alternating magnetic field provides the location and the orientation of the device. With this information, the vector of the coil signal and hence the orientation can be determined from the three components of the magnetic field of the impulse or the damped oscillation. Because the mathematical sign of the transmitted magnetic field associated with the signal is also known, the roll angle is unambiguously defined.

1.-12. (canceled)

13. Apparatus for determining a roll angle of a device, comprising:
a housing enclosing the device,
a coil arranged in or on the housing in a fixed relationship relative to the housing, and
a control electronics connected with the coil and producing a time-limited voltage profile.

14. The apparatus of claim 13, wherein the control electronics in conjunction with the coil produces a pulse-shaped voltage profile.

15. The apparatus of claim 13, wherein the control electronics in conjunction with the coil produces a voltage profile resembling a damped oscillation having a decay time.

16. The apparatus of claim 13, wherein the control electronics repeats the voltage profile with a repeat frequency f.

17. The apparatus of claim 13, wherein the coil has a positive terminal and a negative terminal, and wherein the control electronics generates an electric current flow always in an identical direction from one of the terminals to the other terminal.

18. The apparatus of claim 13, further comprising a second dipole arranged in the housing, and a drive rotating the second dipole about a rotation axis with a relative speed OMEGA relative to the housing.

19. The apparatus of claim 18, wherein the second dipole is implemented as a rotating permanent magnet.

20. The apparatus of claim 18, wherein the rotation axis of the second dipole is oriented perpendicular to an axis of the coil.

21. The apparatus of claim 13, further comprising a receiver arranged external to the device, with the receiver measuring three time-dependent, mutually perpendicular magnetic field components of a magnetic field outside the device.

22. The apparatus of claim 13, wherein the device is a drill head of a drilling device, with the drill head including the housing.

23. The apparatus of claim 13, wherein the device is a medical device selected from the group consisting of a device for obtaining endoscopic images for diagnostic purposes, a device for obtaining electrical or electrophysiological data, a device for examining blood vessels and treatment of vessel constrictions, a device for performing and/or monitoring surgical procedures on the brain, heart or the intestinal tract, a device for implantation of organ and tissue transplants, joint prostheses, electromagnetic sensors and pulse transmitters, heart pacemakers, a device for vessel transplants and catheters, a device for removal and destruction of gallstones or kidney stones, inflamed tissue, tumor tissue, bone and joint material, a device for targeted release of therapeutic substances on diseased tissue or tumor tissue, and a device for irradiation of tumor tissue.

24. A method for determining a roll angle of a device with a housing, comprising the steps of:
producing a time-limited voltage profile with a control electronics and a coil, wherein the coil is fixedly arranged relative to the housing on or in the housing,
measuring a magnetic field outside the housing with a receiver, and
determining the roll angle from a temporal change of the measured magnetic field.
